(19) United States
(12) Patent Application Publication
(10) Pub. No.: US 2008/0174601 A1
(43) Pub. Date: Jul. 24, 2008

(54) Video Control for Providing Multiple Screen Resolutions Using Modified Timing Signal

(75) Inventor: Mostafa Kashi, Sunnyvale, CA (US)

Correspondence Address: FENWICK & WEST LLP, SILICON VALLEY CENTER, 801 CALIFORNIA STREET, MOUNTAIN VIEW, CA, 94041, US

(73) Assignee: PALM, INC., Sunnyvale, CA (US)

(21) Appl. No.: 11/625,796

(22) Filed: Jan. 22, 2007

(51) Int. Cl. G06T 3/40

(52) U.S. Cl. 345/428

(57) ABSTRACT

A video controller providing control signals for one or more screen resolutions. The video controller does not change or modify the pixel data for a video signal with a screen resolution. Accordingly, the video controller does not require additional computing or memory resources. Furthermore, because the video controller can be implemented by counters and logic gates, the video controller does not require additional hardware resources. The video controller also provides a convenient architecture for scrolling images with a higher screen resolution in a viewing device that only supports a lower screen resolution.

### BACKGROUND

1. Field of Art

The disclosure relates generally to video controllers for controlling a viewing device, and more specifically, to video controllers that can scroll a displayed image on a viewing device.

2. Description of Related Art

Most viewing devices are capable of displaying images only at certain screen resolutions. Screen resolutions commonly used by the viewing devices include, among other resolutions, XGA/XVGA (1024×768), SXGA (1280×1024), and UXGA (1600×1200). For digital television and HDTV, vertical resolutions of 720 or 1080 lines are typical. The viewing devices do not display proper images when the received video signals do not match their screen resolutions.

Flat viewing devices have different screen resolution characteristics compared to CRT viewing devices. The CRT viewing devices inherently have a variable resolution and accept multiple screen resolutions. “Multi-sync” circuitry is used in the CRT display to control the CRT raster scan frequency in response to an input video signal. In contrast, the flat panel viewing devices have a fixed screen resolution (i.e., native screen resolution) determined by the number of pixel arrays on the viewing device.

To display images that do not match the native screen resolution, some flat panel viewing devices provide scaling or scrolling functionality. The scaling functionality adjusts original images with screen resolutions other than the native screen resolution to modified images with the native screen resolution. The scaling is accomplished by cropping or replicating selected pixels of the original images horizontally or vertically or both. The scrolling functionality allows an image with a higher screen resolution (e.g., 1024×768) to be displayed on a viewing device with a lower screen resolution by changing the portion of the image to be displayed on the viewing device with the lower screen resolution (e.g., 640×480).

The flat panel viewing devices are controlled by a horizontal synchronization (Hsync) signal, a vertical synchronization (Vsync) signal, a pixel clock signal, a pixel data signal, and a data enable signal. The Hsync signal, the Vsync signal, and the pixel clock signal are timing signals that define a horizontal line of an image, the end of a single image (i.e., frame), and a period for receiving the pixel data, respectively. The data enable signal identifies valid pixel data to be displayed on the viewing device. Some flat panel viewing devices do not support the data enable signal. The pixel data signal includes pixel data for every pixel of the viewing device and is often 18 to 24 bits for each pixel. The pixel data from the pixel data signal is matched with a certain pixel in the viewing device using the Hsync signal, the Vsync signal, the pixel clock signal, and the data enable signal.

One video controller supports only one screen resolution. Therefore, a computing device must use multiple video controllers to support multiple screen resolutions. FIG. 1 shows a conventional computing device 100 displaying two viewing devices with two different screen resolutions. The computing device 100 includes a central processing unit (CPU) 102, a memory device 104, a first display controller 106, a second display controller 108, a first viewing device 110, and a second viewing device 112. The CPU 102, the memory device 104, the first display controller 106, and the second viewing device 112 communicate through a bus 114. The first display controller 106, and the second display controller 108 control the first viewing device 110, and the second viewing device 112, respectively. The two viewing devices 110, 112 have different screen resolutions. Because a display controller can support only one screen resolution, two display controllers 106, 108 are required to control the two viewing devices 110, 112.

Using multiple display controllers often require additional computing, communication, and memory resources. For example, in the computing device 100 of FIG. 1, the CPU 102 must provide two separate sets of video data for two different screen resolutions. The two different sets of video data must be generated using the computing time of the CPU 102, stored on the memory 104, and transferred to the display controllers 106, 108 using the bus 114. Accordingly, using more than one screen resolutions involves increased consumption of computing, memory, and communication resources. The increased consumption of resources may results in overall reduced performance of the computing device 100.

Also, providing multiple display controllers increase the manufacturing cost as well as increasing the size of the computing device to accommodate the additional display controllers.

Therefore, the present art lacks a display controller that can control one or more viewing devices having different screen resolutions. Further, it lacks a display controller that can control multiple viewing devices without requiring additional computing, memory, and communication resources. Still further, it lacks a viewing device that can control multiple viewing devices without bulky, expensive, and complex hardware components.

### SUMMARY

The disclosed embodiments are of a system (or method) configured to address shortcomings of the art, including those previously described. In one example embodiment, a system modifies one or more timing signals of first control signals into one or more timing signals of second control signals. The first control signals control a first viewing device displaying a first image in a first screen resolution. The second control signals control a second viewing device displaying a second image in a second screen resolution. By changing the timing signals, the pixel data of the first image displayed on the second viewing device can be changed.

In another example embodiment, the timing signals include, among other signals, a horizontal synchronization (Hsync) signal, a vertical synchronization (Vsync) signal, a pixel clock signal, and a data enable signal. In one embodiment, the pixel data signal is not modified. The second control signals include the same pixel data signal as the first control signals. Accordingly, additional computing, communication, and memory resources required to generate and send another pixel data signal to the second viewing device can be reduced or eliminated.

In an example embodiment, the triggering edges of the data enable signal are modified. The triggering edges of the data enable signal of the second control signals are delayed by a number of pixel clock signals compared to the triggering edges of the data enable signal of the first control signals. The image of second screen resolution can be scrolled horizontally by varying the amount of time the triggering edges of the data enable signal of the second control signals is delayed relative to the triggering edges of the data enable signal of the first control signals.

In an example embodiment, the pulses of the data enable signal pulses are modified. The starting pulses of the data enables signal of the second control signals are delayed by a number of data enables pulses of the first control signals. The images of the second screen resolution can be scrolled vertically by varying the amount of time the starting pulses of the data enable signal of the second control signals are delayed relative to the data enable signal of the first control signals.

In one example embodiment, the triggering edges of the horizontal synchronization signal are modified. The triggering edges of the horizontal synchronization signal of the second control signals are delayed by a number of pixel clock signals relative to that of the horizontal synchronization signal of the first control signals. The images of the second screen resolution can be scrolled horizontally by varying the amount of time the triggering edges of the horizontal synchronization signal of the second control signals is delayed relative to the triggering edges of the horizontal synchronization signal of the first control signals.

In one example embodiment, the pulses of the horizontal synchronization signal pulses are modified. The starting pulses of the data enables signal of the second control signals are delayed by a number of horizontal synchronization signal pulses of the first control signals. The images of the second screen resolution can be scrolled vertically by varying the amount of time the starting pulses of the horizontal synchronization signal of the second control signals is delayed relative to the horizontal synchronization signal of the first control signals.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 is a block diagram showing a conventional computing device including two display controllers controlling two viewing devices having two different screen resolutions.

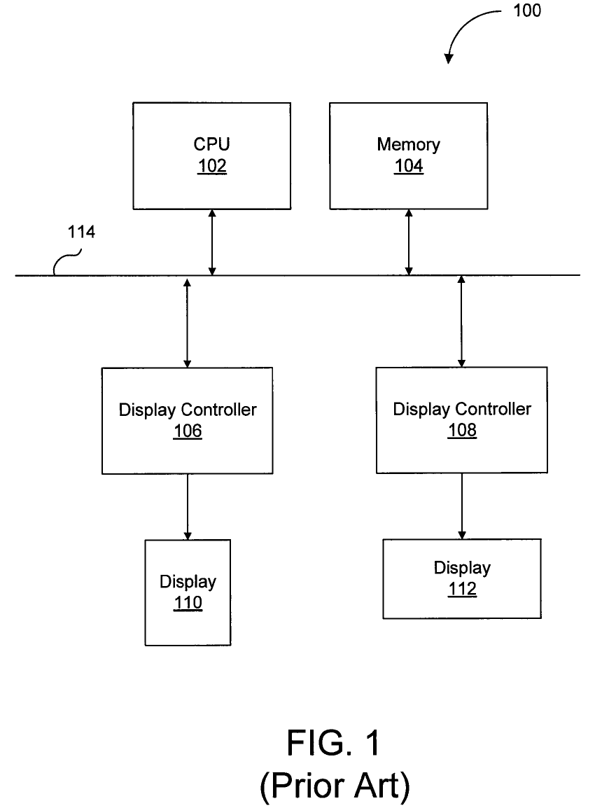

FIG. 2 is a diagram illustrating an embodiment of a second image with a lower screen resolution scrolled to show a portion of a first image with a higher screen resolution.

FIG. 3 is a block diagram illustrating an embodiment of a computing device including a video controller.

FIG. 4 is a block diagram illustrating an embodiment of input signals and output signals of the horizontal delay module, the vertical delay module, and the gate module in a video controller, for example, such as one illustrated in FIG. 3.

FIG. 5 is a timing diagram illustrating embodiments of data enablement signals for horizontally scrolling a second image.

FIG. 6 is a timing diagram illustrating embodiments of pulses of data enable signals for vertically scrolling a second image.

FIG. 7 is a timing diagram illustrating embodiments of horizontal synchronization signals for horizontally scrolling a second image.

FIG. 8 is a timing diagram illustrating embodiments of pulses of horizontal synchronization signals for vertically scrolling a second image.

FIG. 9 is a flow chart illustrating an embodiment of a process for controlling a viewing device to horizontally scroll a second image.

FIG. 10 is a flow chart illustrating an embodiment of a process for controlling a viewing device to vertically scroll a second image.

### DETAILED DESCRIPTION

The embodiments described herein will be with reference to the accompanying drawings. Like reference numerals are used for like elements in the accompanying drawings.

### System Overview

In embodiments described herein, control signals for a viewing device include timing signals and pixel data signals. The timing signals include, among other signals, a horizontal synchronization (Hsync) signal, a vertical synchronization (Vsync) signal, a pixel clock signal, and a data enable signal.

The Hsync signal is the timing signal that defines time during which pixel data for a horizontal line of an image are communicated to the viewing device. The Vsync signal is the timing signal that defines time during which pixel data for an image (i.e., frame) are communicated to the viewing device. The pixel clock signal is the timing signal for indicating time within which the pixel data signal of the control signals includes pixel data for one pixel. The data enable signal identifies the time for valid pixel data within a horizontal line of the image.

The images include both moving and still images. The images can be any type of images that can be displayed on the viewing device including: color images (in various color resolutions), black and white images, and grayscale images.

The pixel data is often Red, Green, Blue (RGB) data having 18 to 24 bits for each pixel. The pixel data signal includes the pixel data in the form of a data stream. One set of RGB data from the pixel data pixel data of the data stream is matched with a certain pixel in the viewing device using the Hsync signal, the Vsync signal, the pixel clock signal, and the data enable signal.

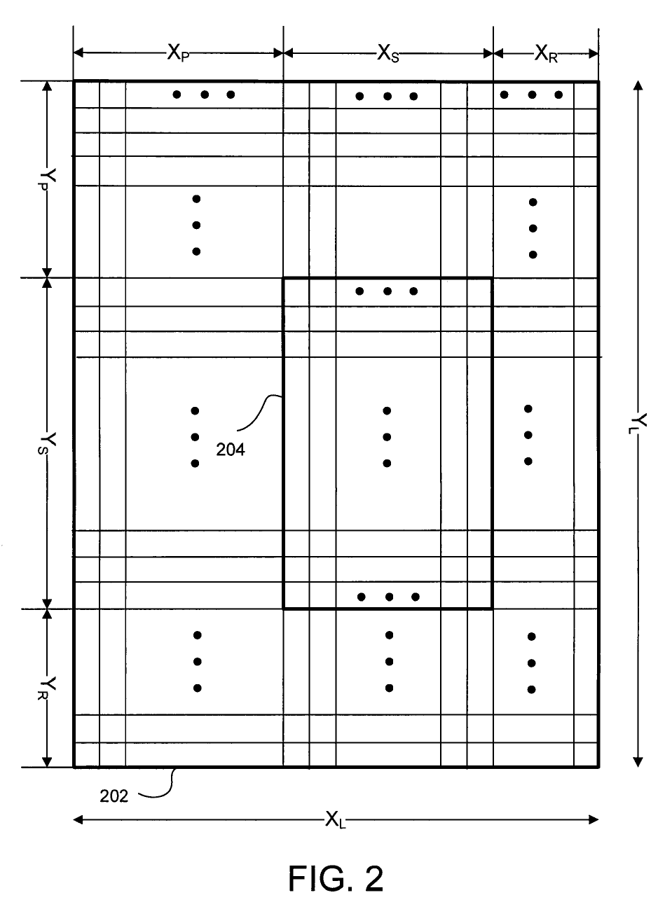

FIG. 2 is a diagram illustrating an embodiment of the second image 204 with a lower screen resolution (X_{S}×Y_{S}) scrolled to show a portion of the first image 202 with a higher screen resolution (X_{L}×Y_{L}). The first image 202 has a horizontal screen resolution of X_{L} and a vertical screen resolution of Y_{L}. The second image 204 has a horizontal screen resolution of X_{S} and a vertical screen resolution of Y_{S}. Although the following embodiments were explained with the second image 204 having lower vertical and horizontal resolutions, the second image 204 may have the same vertical or horizontal resolution as the first image 202. Alternatively, the second image 204 can have a screen resolution higher than that of the first image 202.

In one embodiment, the second image 204 displays only a portion of the first image 202. Specifically, the first horizontal line of the second image 204 is Y_{P} horizontal lines below the first horizontal line of the first image 202. Similarly, the first vertical line (i.e., the leftmost vertical line) of the second image 204 is X_{P} vertical columns offset to the right with respect to the first vertical line of the first image 202.

By changing X_{P} and Y_{P}, the second image 204 can be scrolled to show different portions of the first image 202. When X_{P} increases, the second image 204 scrolls to the right side of the first image 202. Similarly, when Y_{P} increases, the second image 204 scrolls to a lower portion of the first image 202. In contrast, when X_{P} decreases, the second image 204 scrolls to the left side of the first image 202. When Y_{P} decreases, the second image 204 scrolls to an upper portion of the first image 202.

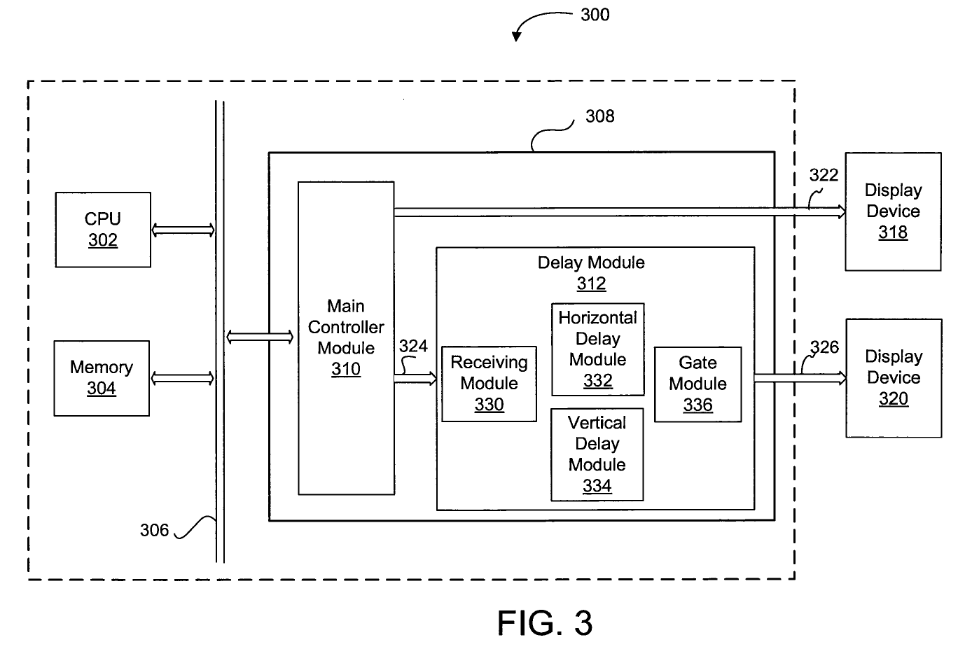

FIG. 3 is a block diagram illustrating an embodiment of a computing device 300 including a video controller. The computing device 300 includes a central processing unit (CPU) 302, a memory 304, a bus 306, and a video controller 308. The video controller 308 communicates with the CPU 302 and the memory 304 through the bus 306. The video controller 308 controls a first viewing device 318, and a second viewing device 320.

It is noted that examples of viewing devices (e.g., 318, 320) include computer monitors (both stand-alone monitors and those integrated with other computing system components), mobile computer devices (e.g., laptops, notebook computers, personal digital assistants, smart phones, etc.), televisions, and projection devices. In addition, the components described herein may be integrated with the viewing device (e.g., 318, 320) or may be structured separate from the actual viewing device, but coupled with it (e.g., in a separate housing or as part of another component such as a digital video recorder (DVR), a digital television set top box, a satellite receiver set top box, a media receiver, or the like).

The video controller 308 includes a main controller module 310, and a delay module 312. Other than providing signals indicating X_{P} and Y_{P} (and possibly X_{S} and Y_{S}) to the delay module 312, the main controller module 310 is a conventional video controller. The main controller module 310 provides first control signals to the first viewing device 318 through a first video interface 322 (e.g., DVI). The first control signals include the timing signals and the pixel data signal for the first image 202 in the first screen resolution. The delay module 312 includes a receiving module 330 for receiving the first control signals, and other control signals (indicating, among others, X_{P}, Y_{P}, X_{S} and Y_{S}) from the main controller module 310 through an internal bus 324. The delay module 312 modifies the received the first control signals and generates second control signals that are sent to the second viewing device 320 through a second video interface 326.

The second control signals include the unmodified pixel data signals of the first control signals and modified timing signals. The pixel data signal of the second control signals is the same as that of the first control signals. Note that the video controller does not need to perform computation or store additional data to generate another set of pixel data for the second control signals because the same pixel data signal is used in both the first control signals and the second control signals. The timing signals of the second control signals, however, are modified as explained below in detail. The modified timing signal is sent to the second viewing device 320 together with the unmodified pixel data signal.

In another embodiment, some or all components of the delay module 312 may be provided on the viewing devices 318, 320. In this embodiment, the viewing devices 318, 320 can display images with various screen resolutions. The scrolling of the images may be performed by manipulating user interface devices (e.g., buttons) provided on the viewing devices 318, 320.

In still another embodiment, some or all components of the delay module 312 may be provided as a device separate from the computing device 300 and the viewing devices 318, 320. In this embodiment, the delay module 312 is implemented as a separate display adapter performing the functions, among other functions, of converting the first control signals into the second control signals.

### Example Embodiments Using Delayed Data Enable Signal

In one example embodiment, consider that the first viewing device 318 can display images in only the first screen resolution and the second viewing device 326 can display images in the second screen resolution. The first screen resolution (X_{L}×Y_{L}) is higher than the second screen resolution (X_{S}×Y_{S}) as shown in, for example, FIG. 2.

The delay module 312 includes a receiving module 330, a horizontal delay module 332, a vertical delay module 334, and a gate module 336. The receiving module 330 receives the first control signals from the main control module 310. The horizontal delay module 332 provides a horizontal delay signal to the gate module 336 to control the horizontal scrolling of the second image 204. The vertical delay module 334 provides a vertical delay signal to the gate module 336 to control the vertical scrolling of the second image 204. The gate module 336 receives the horizontal delay signal, the vertical delay signal, and the data enable signal DE(IN) of the first control signals. The gate module 336 generates a data enable signal DE(OUT) for the second control signals based on the DE(IN), the horizontal delay signal, and the vertical delay signal.

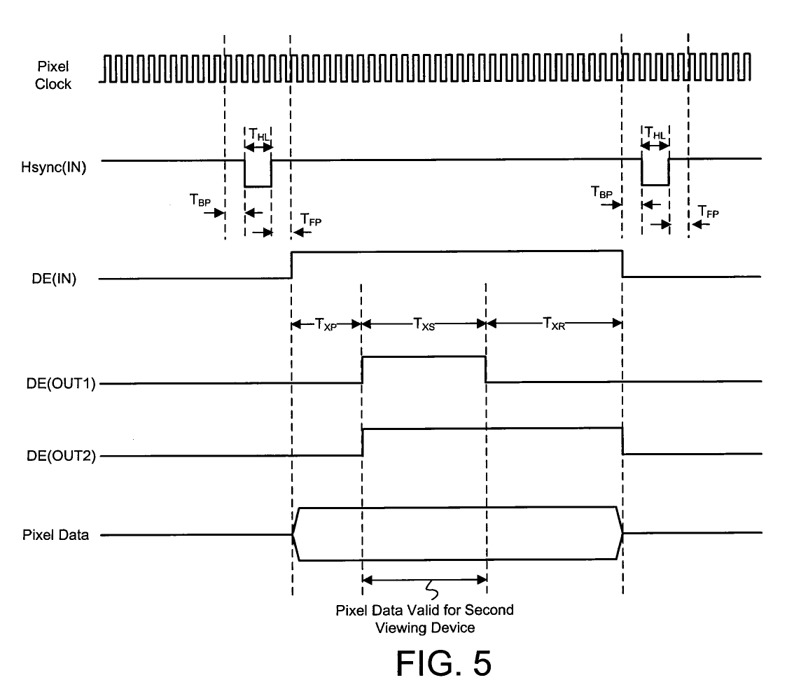

In one embodiment, the horizontal delay signal indicates how many pixel clocks the triggering edge of each pulse of the data enable signal DE(OUT) should lag behind the triggering edge of the corresponding pulse of the data enable signal DE(IN). By controlling the lag time of the triggering edge of each pulse of the data enable signal DE(OUT), the second image 204 can show horizontally scrolled portions of the first image 202 as explained below in detail with reference to FIG. 5.

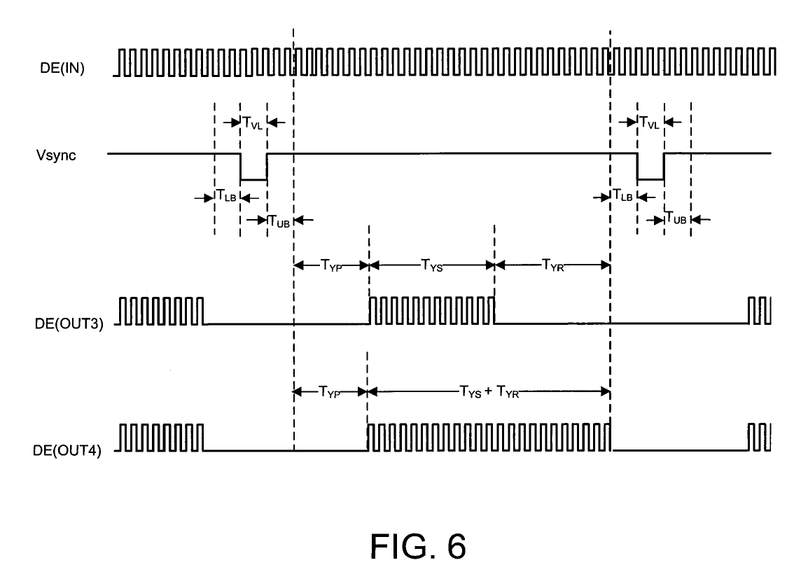

In one embodiment, the vertical delay signal indicates how many pulses of the data enable signal DE(IN) should be blocked or delayed before the pulses appears in the data enable signal DE(OUT). By blocking or delaying the pulse in the data enable signal DE(OUT), the second image 204 can show vertically scrolled portions of the first image 202 as explained below in detail with reference to FIG. 6.

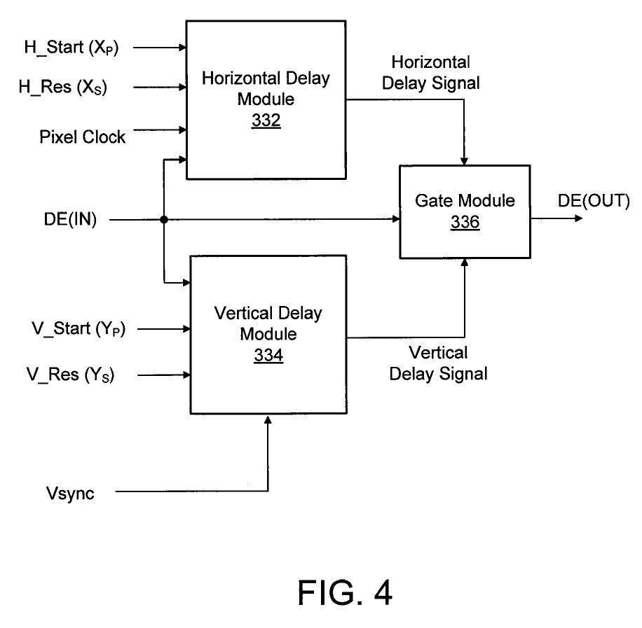

FIG. 4 is a block diagram illustrating an embodiment of the input and output signals of the horizontal delay module 332, the vertical delay module 334, and the gate module 336, for example, as shown in FIG. 3. In one embodiment, the horizontal delay module 332 receives a horizontal start point signal H_Start, a horizontal screen resolution signal H_Res, a pixel clock signal, and the data enable signal DE(IN) of the first control signals. In one embodiment, the H_Start signal indicates the x-coordinate X_{P} of the upper left corner pixel of the second image 204 in the first image 202, and the H_Res indicates the horizontal screen resolution of the second image 204.

In one embodiment, the vertical delay module 334 receives a vertical start point signal V_Start, a vertical screen resolution signal V_Res, the data enable signal DE(IN) of the first control signals, and a vertical synchronization signal Vsync of the first control signals. In one embodiment, the V_Start signal indicates the y-coordinate Y_{P} of the upper left corner pixel of the second image 204 in the first image 202, and the V_Res indicates the vertical screen resolution of the second image 204.

The gate module 336 receives the horizontal delay signal, the vertical delay signal, and the data enable signal DE(IN) of the first control signals. Then, the gate module 336 outputs the data enable signal DE(OUT) of the second control signals.

FIG. 5 is a timing diagram illustrating embodiments of the data enablement signals DE(OUT1) and DE(OUT2) for the second control signals. In this example, the horizontal synchronization signal is asserted when the signal is low. A back porch T_{BP} is provided before the Hsync(IN) turns from high to low and a front porch T_{FP} is provided before the Hsync(IN) turns from low to high. The data enable signal DE(IN) of the first control signals is asserted when it turns from low to high. The DE(IN) signal turns from low to high after the Hsync(IN) signal turns from low to high. The data enable signal DE(IN) remains high until it is time for the back porch T_{BP} to start.

In one example embodiment, the triggering edges of the data enable signal DE(OUT1) of the second control signals lags the triggering edges of the first control signals by T_{XP}. The triggering edges of the data enable signal refer to the rising edges of the data enable signal at which the data enable signal turns from low to high. T_{XP} is the time during which the pixel data signal indicates the pixel data of first to (X_{P})th pixels in a horizontal line of the first image 202. T_{XP} corresponds to X_{P} times the period of the pixel clocks T_{PC} (i.e., T_{XP}=X_{P}×T_{PC}). In this embodiment, the DE(OUT1) stays high for the time T_{XS} before turning low.

Note that T_{XS} is the time during which the pixel data signal includes pixel data for (X_{P}+1)th pixel to (X_{P}+X_{S})th pixel in a horizontal line of the first image 202. In addition, T_{XS} corresponds to the screen resolution of the second image X_{S} times the period of the pixel clocks T_{PC} (i.e., T_{XS}=X_{S}×T_{PC}). The DE(OUT1) stays low for the remaining time T_{XR}. Also, T_{XS} is the time during which the pixel data of the pixel data signal indicates (X_{P}+X_{S})th pixel to the last pixel (XL) in a horizontal line of the first image 202. T_{XR} corresponds to X_{R}(=X_{L}−X_{P}−X_{S}) times the period of the pixel clocks T_{PC} (i.e., T_{XR}=X_{R}×T_{PC}). In another embodiment, the triggering edges of the data enable signal DE(OUT2) of the second control signals lags behind the data enable signal DE(IN) of the first control signals by T_{XP}, and remains high until it is time for the back porch T_{BP} to start. The second viewing device 320 does not display the pixel data received during T_{XR}.

By delaying the triggering edges of the data enable signal DE(OUT1) or DE(OUT2), pixels corresponding to the pixel data coming before the triggering edges of the DE(OUT1) or DE(OUT2) are not displayed on the second viewing device 320. Therefore, a pixel data for a pixel having an x-coordinate of X_{P} in the first image 202 becomes the pixel data for a left end pixel in the second image 204 (with the horizontal lines of the second image 204 offset with respect to those of the first image 202 as explained below with reference to FIG. 6). The second image 204 is scrolled horizontally by increasing or decreasing the delayed time T_{XP} of the data enable signal DE(OUT1) or DE(OUT2). The data enable signal DE(OUT1) or DE(OUT2) for each horizontal line in the first image 202 is delayed by the same amount of time T_{XP} so that all of the horizontal lines in the second image 204 are offset by the same number of pixels X_{P} relative to the first image 202.

In one embodiment, the horizontal delay module 332 is a counter that generates the horizontal delay signal based on the pixel clock and the data enable signal DE(IN). Specifically, the horizontal delay module 332 counts the pixel clock and turns the horizontal delay signal low only after the count of the pixel clock reaches X_{P} after the DE(IN) signal is triggered. When the horizontal delay signal turns high, the gate module 336 blocks the DE(IN) signal, keeping the DE(OUT1) or the DE(OUT2) signal low. Once the horizontal delay signal turns high, the gate module 336 allows the DE(OUT1) or the DE(OUT2) signal to include pulses, the sequence of which is identical to those of the DE(IN) signal. In one embodiment (e.g., when generating the DE(OUT1) signal), the horizontal delay module 332 resets after the count of the pixel reaches X_{P}+X_{S}. In another embodiment (e.g., when generating the DE(OUT2) signal), the horizontal delay module 332 resets after the count of the pixel reaches X_{L}. Once the horizontal delay module 332 is reset, the horizontal delay signal returns to high and the DE(OUT1) or the DE(OUT2) turns to low. The same process is repeated for (Y_{P}+1)th to (Y_{P}+Y_{S})th horizontal lines of the first image 202.

FIG. 6 is a timing diagram showing the pulses of the data enablement signals DE(OUT3) and DE(OUT4) for the second control signals according to embodiments of the invention. The vertical synchronization signal Vsync indicates the end of an image (i.e., frame). In the example of FIG. 6, the Vsync is asserted when the signal turns from low to high. The number of pulses of data enable signal DE(IN) appearing between the Vsync pulses corresponds to the vertical resolution of the first image 202. Before and after the Vsync signal turns low, a lower blank time T_{LB} and an upper blank time T_{UB} are provided, respectively. The data enable signal DE(IN) remains low during the time T_{VL} (time the Vsync signal stays low), and during the lower blank time T_{LB} and the upper blank time T_{UB} of the Vsync signal. Note that each pulse of the data enable signal DE(OUT3) or DE(OUT4) in FIG. 6 has the waveform of DE(OUT1) or DE(OUT2) as shown in FIG. 5.

T_{YP} is the time during which the pixel data of the pixel data signal indicate the pixels from the first to the (Y_{P})th horizontal line of the first image 202. T_{YP} corresponds to the number of horizontal lines Y_{P} times the period of the data enable pulses T_{DE} (i.e., T_{YP}=Y_{P}×T_{DE}). In this embodiment, the pulse of DE(OUT3) oscillates for T_{YS} before it is blocked. T_{YS} is the time during which the pixel data of the pixel data signal indicates pixels for (Y_{P}+1)th to (Y_{P}+Y_{S})th horizontal lines of the first image 202. T_{YS} corresponds to the screen resolution of the second image Y_{S} times the period of the data enable pulses (i.e., T_{YS}=Y_{S}×T_{DE}). Thereafter, the DE(OUT1) is blocked for the remaining time T_{YR}. T_{YR} is the time during which the pixel data of the pixel data signal indicates pixels for (Y_{P}+Y_{S})th to the last (Y_{L}) horizontal lines of the first image 202. T_{XR} corresponds to X_{R}(=X_{L}−X_{P}−X_{S}) times the period of the data enable pulses T_{DE} (i.e., T_{XR}=X_{R}×T_{DE}). In another embodiment, the pulses of the data enable signal DE(OUT4) is generated until it is time for the lower blank time T_{LB} to start. The second viewing device 320 does not display the pixel data received during T_{YR}.

By delaying the start of the data enable pulses in the data enable signal DE(OUT3) or DE(OUT4), the pixel data of the pixel data signal appearing before the pulses of DE(OUT3) or DE(OUT4) are not displayed on the second viewing device 320. Therefore, the horizontal line of the first image 202 other than the first horizontal line of the first image 202 becomes the first horizontal line of the second image 204. The second image 204 can be scrolled vertically to show portions of the first image 202 by controlling the delayed or blocked pulses of the data enable signal DE(OUT3) or DE(OUT4).

In one embodiment, the vertical delay module 334 is a counter that generates the vertical delay signal based on the data enable signal DE(IN). Specifically, the vertical delay module 334 counts the data enable pulses of the data enable signal DE(IN) and asserts the vertical delay signal only after the count of the pixel clock reaches Y_{P}. When the vertical delay signal is de-asserted, the gate module 336 blocks the DE(IN) signal and the DE(OUT3) or the DE(OUT4) signal stays low. Once the vertical delay signal is asserted, the gate module 336 allows the pulses to appear in the DE(OUT3) or the DE(OUT4) signal. In one embodiment (e.g., when generating the DE(OUT3) signal)), the vertical delay module 334 resets after the count of the data enable pulses reaches Y_{P}+Y_{S}. In another embodiment (e.g., when generating the DE(OUT4) signal), the horizontal delay module 334 resets after receiving the Vsync pulse. Once the horizontal delay module 332 is reset, the horizontal delay signal returns to a de-asserted state. Thus, the DE(OUT3) or the DE(OUT4) signal turns low. The same process is repeated for each image.

In one embodiment, the gate module 336 generates the DE(OUT) signal based on the horizontal delay signal and the vertical delay signal.. The triggering edge of each DE(OUT1) or DE(OUT2) pulse is delayed based on the horizontal delay signal as explained above with reference to FIG. 5. The pulses of the DE(OUT3) or DE(OUT4) are blocked by the gate module 336 based on the vertical delay signal as explained above with reference to FIG. 6. Accordingly, the DE(OUT) from the gate module 336 has pulses sequences corresponding to the DE(OUT3) or DE(OUT4), with each pulses having the waveform of DE(OUT1) or DE(OUT2) as shown in FIG. 5.

### Example Embodiments Using Delayed Horizontal Synchronization Signal

In some viewing devices, the data enable signal is not supported. In such devices, a modified Hsync signal can be used instead of the data enable signal to scroll the second image 204.

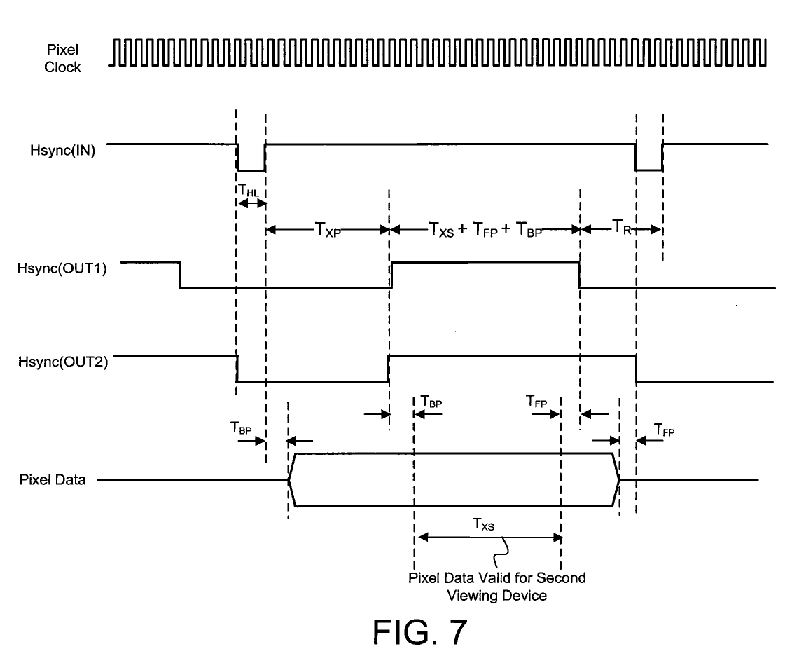

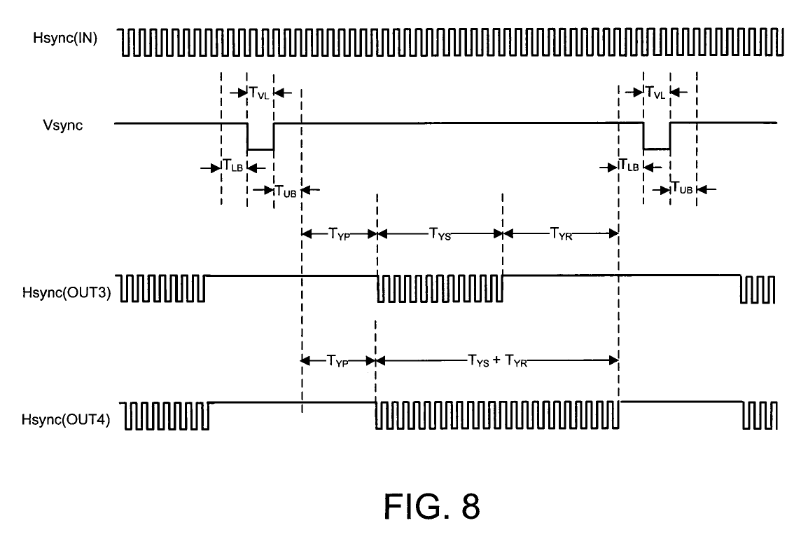

In embodiments using the Hsync signal, the data enable signal is replaced with the Hsync signal. The DE(IN) of FIG. 4 is replaced with the horizontal synchronization signal Hsync(IN) of the first control signals. Likewise, the output data enable signal DE(OUT) from the gate module 336 is replaced with the Hsync(OUT). The waveform of the Hsync(OUT) pulse signals is different from the waveform of the above DE(OUT) signal because the time at which the Hsync(IN) turns high does not coincide with the time at which the pixel data signal of the first control signals includes valid pixel data. That is, the valid pixel data appear after the back porch T_{BP} that comes after the Hsync signal turns high. Likewise, the end of valid pixel precedes the time at which the Hsync signal turns low by the front porch T_{FP}. The timing of the Hsync(OUT) signal is explained below in detail with reference to FIGS. 7 and 8. The horizontal delay module 332, the vertical delay module 334, and the gate module 336 using the Hsync signal functions in the same manner as explained above with reference to embodiments using the data enable signals.

FIG. 7 is a timing diagram showing the horizontal synchronization signals Hsync(OUT1) or Hsync(OUT2) for the second control signals according to embodiments of the invention. The horizontal synchronization signal Hsync(IN) of the first control signal turns from low to high periodically to indicate the end of a horizontal line of the first image 202. Each triggering edge of the horizontal synchronization signal (edge where the signal turns from low to high) indicates that one horizontal line of an image has ended. Valid pixel data lags the triggering edge of the Hsync(IN) signal by the back porch T_{BP}. A front porch T_{FP} is also provided between the time the valid pixel data ends and the time the Hsync(IN) signal turns low.

In one embodiment, the triggering edge of the horizontal synchronization signal Hsync(OUT1) is delayed by extending the time the Hsync(OUT1) stays low. In a cycle of the Hsync signal, the Hsync(OUT1) stays high for the time T_{XS}+T_{FP}+T_{BP}. For the remaining time T_{R} of the Hsync signal cycle, the Hsync(OUT1) stays low.

In another embodiment, the Hsync(OUT2) turns low at the same time as the Hsync(IN) signal, but stays low for a longer duration of T_{HL}+T_{XP} compared to the Hsync(IN) signal. Therefore, the triggering edge of the Hsync(OUT2) is also delayed by T_{XP} compared to the Hsync(IN).

By delaying the triggering edges of the Hsync (OUT I) or the Hsync(OUT2) of the second control signals, only the pixel data of the first control signals coming after the front porch T_{FP} (after the Hsync (OUT 1) turns from low to high) is displayed on the second viewing device 320. Therefore, a pixel having an x-coordinate of X_{P} in the first image 202 becomes the pixel data for a left end pixel in the second image 204 (the horizontal lines of the second image 204 is offset with respect to those of the first image 202 as explained below with reference to FIG. 7). The second image 204 is scrolled horizontally by increasing or decreasing the delayed time T_{XP} of the Hsync(OUT1) or the Hsync(OUT2). The horizontal synchronization signal Hsync(OUT1) or Hsync(OUT2) for each horizontal line in the first image 202 is delayed by the same amount of time T_{XP} so that all of the horizontal lines in the second image 204 are offset by the same number of pixels X_{P} with respect to the first image 202.

In one embodiment, the horizontal delay module 332 is a counter that generates the horizontal delay signal based on the pixel clock and the horizontal synchronization signal Hsync(IN). Specifically, the horizontal delay module 332 counts the pixel clock and asserts the horizontal delay signal only after the count of the pixel clock reaches X_{P}. Once the horizontal delay signal is asserted, the gate module 336 turns the Hsync (OUT1) or the Hsync(OUT2) signal from low to high.

FIG. 8 is a timing diagram showing the pulses of the horizontal synchronization signals Hsync(OUT3) and Hsync(OUT4) for the second control signals according to embodiments of the invention. The horizontal synchronization signal Hsync(IN) remains high during the time T_{VL} (when the Vsync signal is low), the lower blank time T_{LB}, and the upper blank time T_{UB} Note that each pulse of the Hsync(OUT3) or Hsync(OUT4) in FIG. 7 has the waveform of the Hsync(OUT1) or the Hsync(OUT2) as explained above with reference to FIG. 7.

By delaying the start of the horizontal synchronization pulses in the second control signals, the pixel data of the first control signals coming before the pulses are displayed on the second viewing device 320. Accordingly, a horizontal line other than the first horizontal line of the first image 202 becomes the first horizontal line of the second image 204. Therefore, the second image 204 is scrolled vertically with respect to the first image 202 by controlling the delayed or blocked pulses of the Hsync(OUT3) or the Hsync(OUT4).

In one embodiment, the vertical delay module 334 is a counter that generates the vertical delay signal based on the horizontal synchronization signal Hsync(IN). Specifically, the vertical delay module 334 counts the data enable pulses of the data enable signal Hsync(IN), and asserts the vertical delay signal only after the count of the pixel clock reaches Y_{P}. When the vertical delay signal is de-asserted, the gate module 336 blocks the Hsync (IN) signal, and the Hsync(OUT3) or the Hsync(OUT4) signal stays high. Once the vertical delay signal is asserted, the gate module 336 allows the Hsync(OUT3) or the Hsync(OUT4) signal to include pulses, the sequence of which resembles the Hsync (IN) signal. In one embodiment (e.g., when the output is Hsync(OUT3)), the vertical delay module 334 resets after the count of the Hsync(IN) pulses reaches Y_{P}+Y_{S}. In another embodiment (e.g., when the output is Hsync(OUT4)), the horizontal delay module 334 resets after receiving the Vsync pulse. Once the horizontal delay module 332 is reset, the horizontal delay signal returns to a de-asserted state, keeping the Hsync(OUT3) of the Hsync(OUT4) high until it is time for the next T_{YP} to start.

In one embodiment, the gate module 336 generates the Hsync(OUT) based on the horizontal delay signal, and the vertical delay signal.. Each triggering edge of the Hsync(OUT1) or the Hsync(OUT2) pulse is delayed based on the horizontal delay signal as explained above with reference to FIG. 7. In one embodiment, the pulses for the Hsync(OUT3) or Hsync(OUT4) are blocked by the gate module 336 based on the vertical delay signal as explained above with reference to FIG. 8. Accordingly, the Hsync(OUT) from the gate module 336 has pulses sequences corresponding to Hsync(OUT3) or the Hsync(OUT4), with each pulses having the waveform of Hsync(OUT1) or the Hsync(OUT2) of FIG. 7.

It is to be noted that the polarity of any of the timing signals can be reversed in the embodiments. For example, the horizontal synchronization signal may be asserted when the signal is high, Likewise, the data enable signal may be asserted when the signal is low.

### Example Process for Controlling a Viewing Device

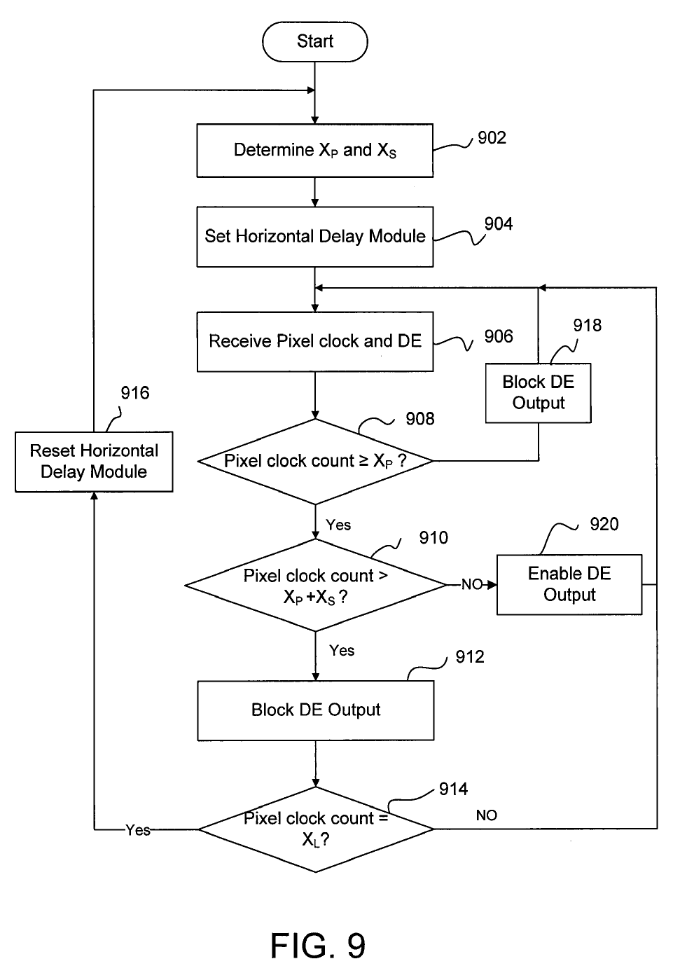

FIG. 9 is a flow chart illustrating one embodiment of a process for controlling the second viewing device 320 to horizontally scroll the second image 204. In the embodiment of FIG. 9, delaying the data enable signal DE(OUT) is used to scroll the second image 204. Note that the same method can be implemented using a horizontal synchronization signal.

First, the video controller 300 determines 902 X_{P} and X_{S}. X_{P} can be extracted from data that the video controller 300 receives from the bus 306. In one embodiment, a user may change X_{P} by taking scrolling actions on a keyboard or a mouse. In response, X_{P} corresponding to the user's scrolling actions is generated by the computing device 300, and is sent to the video controller 300. X_{S} can be automatically detected from plug-and-play feature of the second viewing device. Alternatively, the user may set the horizontal resolution X_{S} of the second viewing device manually.

Next, the horizontal delay module 332 is set 904 using X_{P} and X_{S}. In one embodiment, the horizontal delay module 332 includes one or more configurable counters. In this embodiment, X_{P} and X_{S} may be used for setting the parameters of the counters.

Then, the horizontal delay module 332 receives 906 the pixel clock signal, and the data enable signal DE(IN) of the first control signals. In one embodiment, the delay module 312 extracts the DE(IN) signal from the first control signals provided by the main controller module 310.

Then, the horizontal delay module 332 determines 908 the count of the pixel clock. If the pixel clock count is below X_{P}, then the DE(OUT) signal is blocked 918 and the DE(OUT) signal does not turn high. After blocking 918 the DE(IN) signal, the process returns to the step 906, and the subsequent steps are repeated. If the pixel clock count equals or exceeds X_{P}, the horizontal delay module 332 determines 910 whether the pixel clock count exceeds X_{P}+X_{S}.

If the pulse clock count exceeds X_{P}+X_{S}, the DE(OUT) signal is blocked 912 and the DE(OUT) signal does not turn high. Note that in one embodiment the step 910 may be necessary when generating an output data enable signal DE(OUT) with the waveform of DE(OUT1) shown in FIG. 5. When generating an output data enable signal with the waveform of DE(OUT2) shown in FIG. 5, the step 910 can be omitted. If the pixel clock count does not exceed X_{P}+X_{S}, the data enable signal DE(OUT) is enabled 920 and the DE(IN) signal turns high. Then the process returns to the step 906. After blocking 912 the data enable signal DE(OUT), it is determined 914 whether the pixel clock count equals X_{L}. If the pixel clock count equals X_{L}, the horizontal delay module 332 is reset 916. Then, the process returns to the step 902, and the subsequent steps are repeated. If the pixel clock count does not equal X_{L}, then the process returns to the step 906, and the subsequent steps are repeated.

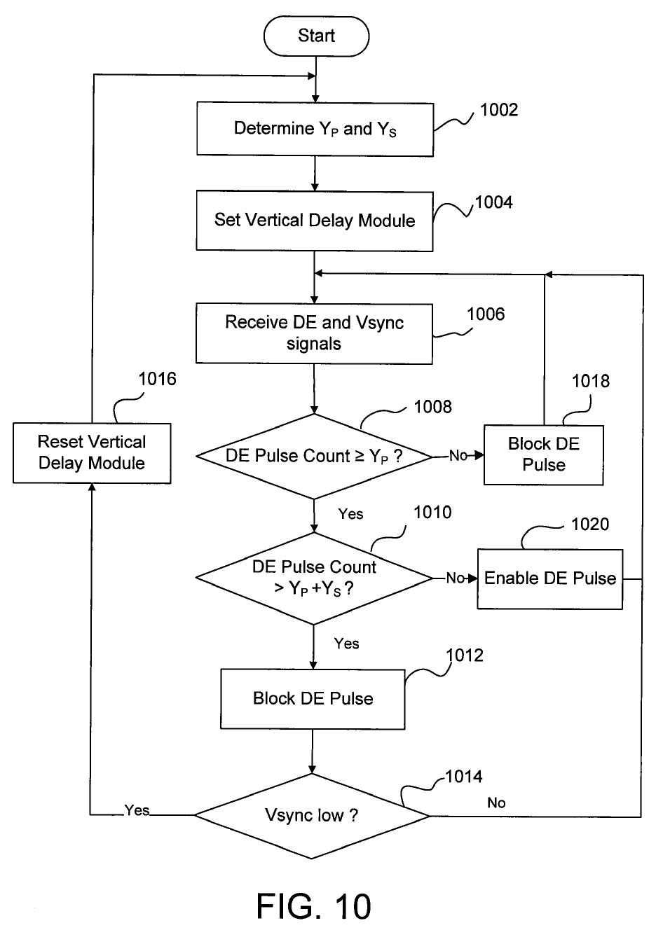

FIG. 10 is a flow chart illustrating an embodiment of a process for controlling the second viewing device 320 so that the second image 204 scrolls vertically. In the embodiment of FIG. 10, the data enable pulses are blocked or delayed to scroll the second image 204. Note that the same method can be implemented by blocking the Hsync pulses.

First, the video controller 300 determines 1002 Y_{P} and Y_{S}. Y_{P} can be extracted from data that the video controller 300 received from the bus 306 as explained above with reference to FIG. 9. Y_{S} can be automatically determined or manually set by the user as explained above with reference to FIG. 9.

Then, the vertical delay module 334 is set 1004 using Y_{P} and Y_{S}. In one embodiment, the vertical delay module 334 includes one or more configurable counters. In this embodiment, Y_{P} and Y_{S} is be used for setting the parameters of the counters.

Then, the vertical delay module 334 receives 1006 the DE(IN) and the Vsync signals of the first control signals. In one embodiment, the delay module 312 extracts the DE(IN) signal and the Vsync signal from the first control signals provided by the main controller module 3 10.

Then, the vertical delay module 334 determines 1008 the count of the DE(IN) pulses. If the DE(IN) pulse count is below Y_{P}, then the DE(OUT) pulses are blocked 1018. While the DE(OUT) pulses are blocked, pulses do not show up in the DE(OUT) signal. Then the process returns to the step 1006, and the subsequent steps are repeated. If the DE(IN) pulse count equals or exceeds Y_{P}, then it is determined 1010 whether the DE(IN) pulse count exceeds Y_{P}+Y_{S}. If the DE(IN) pulse count exceeds Y_{P}+Y_{S}, the DE(OUT) pulses are blocked 1012.

Note that in one embodiment the step 1010 is necessary only when generating a pulse sequence such as the DE(OUT3) of FIG. 5. When generating a pulse sequence such as DE(OUT4) of FIG. 5, the step 1010 can be omitted. If the DE(IN) pulse count does not exceed Y_{P}+Y_{S}, the DE pulses are enabled 1020. Once the DE(OUT) pulses are enabled 1020, the pulses for the DE(OUT) signal are generated. Then the process returns to the step 1006, and the subsequent steps are repeated. After blocking 1012 the DE(OUT) pulses, it is determined 1014 whether the Vsync signal has turned low. If the Vsync signal has turned low, the vertical delay module 334 is reset 1016. Then the process returns to the step 1002, and the subsequent steps are repeated. If the Vsync signal has not turned low, then the process returns to the step 1006, and the subsequent steps are repeated.

The above method of scrolling the second image 204 horizontally as explained with reference to FIG. 9 can be used in conjunction with the above method of scrolling the second image 204 vertically. Using both methods the second image 204 can be scrolled vertically and horizontally.

### Alternate System (or Method) Embodiments

In one embodiment, the pixel clocks are blocked or delayed for a predetermined amount of time. By blocking or delaying the pixel clocks, pixel data of a column other than the first column of the first image 202 becomes the first column of the second image 204. In this embodiment, other control signals may be used in conjunction with the modified pixel clock signal.

In another embodiment, the second control signal can be modified to achieve magnification of the first image 202. In this embodiment, the second image 204 has a higher screen resolution than the first image. Therefore, the first image will takes up only a portion of the second image 204 if the second control signal is not modified. The pixel clock pulse may be shortened in the second control signals so that the pixel data of one pixel in the first image corresponds to more than one pixels in the second image 204.

In yet another embodiment, the vertical delay is implemented by modifying the Vsync signal. Specifically, in this embodiment, the duration T_{VL} (shown in FIGS. 6 and 8) during which the Vsync signal stays low is modified in the second control signals. The pulses of the data enable (DE) signal or the pulses of the Hsync may or may not be blocked. Only the pulses of the data enable (DE) signal or the pulses of the Hsync after the Vsync signal turns high are treated as valid. Therefore, by extending the T_{VL}, and changing the valid pulses of the data enable (DE) signal or the pulses of the Hsync, the horizontal line of the first image 202 corresponding to the first horizontal line of the second image 204 can be changed. This results in vertical scrolling of the second image 204.

The display controllers of the above embodiments has the advantage of controlling one or more viewing devices having different screen resolutions without requiring additional computing, memory, and communication resources that are typically needed to generate different set of pixel data for each screen resolution. The display controllers of the above embodiments also have the advantage of providing scrolling functionality using only simple and inexpensive hardware components.

The various embodiments disclosed herein may be implemented using one or more hardware elements. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. The embodiments are not limited in this context.

Various embodiments may be implemented using one or more software elements. In general, a software element may refer to any software structures arranged to perform certain operations. In one embodiment, for example, the software elements may include program instructions and/or data adapted for execution by a hardware element, such as a processor. Program instructions may include an organized list of commands comprising words, values or symbols arranged in a predetermined syntax, that when executed, may cause a processor to perform a corresponding set of operations.

The software may be written or coded using a programming language. Examples of programming languages may include C, C++, BASIC, Perl, Matlab, Pascal, Visual BASIC, JAVA, ActiveX, assembly language, machine code, and so forth. The software may be stored using any type of computer-readable media or machine-readable media. Furthermore, the software may be stored on the media as source code or object code. The software may also be stored on the media as compressed and/or encrypted data. Examples of software may include any software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. The embodiments are not limited in this context.

Some embodiments may be implemented, for example, using any computer-readable media, machine-readable media, or article capable of storing software. The media or article may include any suitable type of memory unit, memory device, memory article, memory medium, storage device, storage article, storage medium and/or storage unit, such as any of the examples described with reference to a memory. The media or article may comprise memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), subscriber identify module, tape, cassette, or the like. The instructions may include any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, JAVA, ActiveX, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or viewing devices. The embodiments are not limited in this context.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of embodiments of the present invention. This was done merely for convenience and to give a general sense of the embodiments of the present invention. This description should be read to include one or at least one and the singular also includes the plural unless it is obvious that it is meant otherwise.

Upon reading this disclosure, those of skill in the art will appreciate still additional alternative structural and functional designs for a system and a process for a software configured multimedia control mechanism through the disclosed principles herein. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A method of controlling a viewing device comprising:
receiving a first timing signal and a second timing signal at a video controller, the first timing signal and the second timing signal associating pixel data with a plurality of pixels of a first image in a first screen resolution;
generating a third timing signal from the first timing signal and the second timing signal, the third timing signal in conjunction with the second timing signal associating the pixel data with a plurality of pixels of a second image in a second screen resolution; and
transmitting the second timing signal and the third timing signal to a viewing device operable to display the second image in the second screen resolution to display the second image on the viewing device.

2. The method of claim 1, wherein the first timing signal comprises a first data enable signal, the second timing signal comprises a pixel clock signal, and the third timing signal comprises a second data enable signal.

3. The method of claim 2, wherein the first data enable signal includes first triggering edges, and the second data enable signal includes second triggering edges, the second triggering edges trailing the first triggering edges by a number of pixel clock signals.

4. The method of claim 2, wherein the first data enable signal includes a series of first data enable signal pulses, and the second data enable signal includes a series of second data enable signal pulses, a starting data enable signal pulse of the second data enable signal trailing a starting data enable signal pulse of the first data enable signal by a number of first data enable signal pulses.

5. The method of claim 1, wherein the first timing signal comprises a first horizontal synchronization signal, the second timing signal comprises a pixel clock signal, and the third timing signal comprises a second horizontal synchronization signal.

6. The method of claim 4, wherein the first horizontal synchronization signal includes first triggering edges, and the second horizontal synchronization signal includes second triggering edges, the second triggering edges trailing the first triggering edges by a number of pixel clock signals.

7. The method of claim 5, wherein the first horizontal synchronization signal includes a series of horizontal synchronization signal pulses, and the second horizontal synchronization signal includes a series of second horizontal synchronization signal pulses, a starting horizontal pulse of the second horizontal synchronization signal trailing a starting horizontal synchronization pulse of the first horizontal synchronization signal by a number of first horizontal synchronization signal pulses.

8. The method of claim 1 further comprising receiving a configuration signal representing a time between a triggering edge of the third timing signal and a triggering edge of the first timing signal.

9. The method of claim 1 further comprising providing a stream of the pixel data synchronized with the first and second timing signals to the viewing device.

10. A delay module for use in a video control device, the delay module comprising:
a receiving module configured to receive a first timing signal and a second timing signal, the first timing signal and the second timing signal associating pixel data with a plurality of first pixels of a first image in a first screen resolution; and
a gate module coupled to the receiving module, the gate module configured to generate a third timing signal from the first timing signal and the second timing signal, the third timing signal in conjunction with the second timing signal associating the pixel data with a plurality of second pixels of a second image in a second screen resolution.

11. The delay module of claim 10, wherein the first timing signal comprises a first data enable signal, the second timing signal comprises a pixel clock signal, and the third timing signal comprises a second data enable signal.

12. The delay module of claim 11, wherein the first data enable signal includes first triggering edges, and the second data enable signal includes second triggering edges, the second triggering edges trailing the first triggering edges by a number of pixel clock signals.

13. The delay module of claim 11, wherein the first data enable signal includes a series of first data enable signal pulses, and the second data enable signal includes a series of second data enable signal pulses, a starting data enable signal pulse of the second data enable signal trailing a starting data enable signal pulse of the first data enable signal by a number of first data enable signal pulses.

14. The delay module of claim 10, wherein the first timing signal comprises a first horizontal synchronization signal, the second timing signal comprises a pixel clock signal, and the third timing signal comprises a second horizontal synchronization signal.

15. The delay module of claim 13, wherein the first horizontal synchronization signal includes first triggering edges, and the second horizontal synchronization signal includes second triggering edges, the second triggering edges trailing the first triggering edges by a number of pixel clock signals.

16. The delay module of claim 13, wherein the first horizontal synchronization signal includes a series of horizontal synchronization signal pulses, and the second horizontal synchronization signal includes a series of second horizontal synchronization signal pulses, a starting horizontal pulse of the second horizontal synchronization signal trailing a starting horizontal synchronization pulse of the first horizontal synchronization signal by a number of first horizontal synchronization signal pulses.

17. A computing device comprising:
a processor;
a data storage device coupled to the processor; and
a display controller, coupled to the processor, the display controller comprising:
a receiving module configured to receive a first timing signal and a second timing signal, the first timing signal and the second timing signal associating pixel data with a plurality of first pixels of a first image in a first screen resolution; and
a gate module coupled to the receiving module, the gate module configured to generate a third timing signal from the first timing signal and the second timing signal, the third timing signal in conjunction with the second timing signal associating the pixel data with a plurality of second pixels of a second image in a second screen resolution.

18. The computing device of claim 17, wherein the first timing signal comprises a first data enable signal, the second timing signal comprises a pixel clock signal, and the third timing signal comprises a second data enable signal.

19. The computing device of claim 18, wherein the first data enable signal includes first triggering edges, and the second data enable signal includes second triggering edges, the second triggering edges trailing the first triggering edges by a number of pixel clock signals.

20. The computing device of claim 18, wherein the first data enable signal includes a series of first data enable signal pulses, and the second data enable signal includes a series of second data enable signal pulses, a starting data enable signal pulse of the second data enable signal trailing a starting data enable signal pulse of the first data enable signal by a number of first data enable signal pulses.

21. The computing device of claim 17, wherein the first timing signal comprises a first horizontal synchronization signal, the second timing signal comprises a pixel clock signal, and the third timing signal comprises a second horizontal synchronization signal.

22. The computing device of claim 20, wherein the first horizontal synchronization signal includes first triggering edges, and the second horizontal synchronization signal includes second triggering edges, the second triggering edges trailing the first triggering edges by a number of pixel clock signals.

23. The computing device of claim 20, wherein the first horizontal synchronization signal includes a series of horizontal synchronization signal pulses, and the second horizontal synchronization signal includes a series of second horizontal synchronization signal pulses, a starting horizontal pulse of the second horizontal synchronization signal trailing a starting horizontal synchronization pulse of the first horizontal synchronization signal by a number of first horizontal synchronization signal pulses.
